(19) United States
(12) Patent Application Publication
(10) Pub. No.: US 2007/0192602 A1
(43) Pub. Date: Aug. 16, 2007

(54) Clone resistant mutual authentication in a radio communication network

(75) Inventors: Rolf Jorgen Blom, Jarfalla (SE); Mats Naslund, Vallingby (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/275,166

(22) Filed: Dec. 16, 2005

Related U.S. Application Data
(60) Provisional application No. 60/636,906, filed on Dec. 17, 2004.

(51) Int. Cl. H04L 9/00

(52) U.S. Cl. 713/169

(57) ABSTRACT

A system and method for preventing unauthorized duplication of an identity module, IM, and authenticating valid IMs. Different information is stored in the IM and an authentication center, AuC, and if the information in the AuC is leaked, it is insufficient to clone the IM. The IM generates a first key, K1, and a second key, K2, while assuring that K1 cannot be derived from K2, and optionally that K2 cannot be derived from K1. The IM exports K2 and an identifier to the AuC while keeping K1 secret within the IM. During authentication, the IM provides to a third party such as a VLR, information containing the identifier. The VLR forwards the information to the AuC, which retrieves K2 based on the identifier and generates a first value, R, and a second value, X, based on at least K2. The AuC then returns R and X to the VLR, which forwards R to the IM. The IM then generates a response, RES, based on at least K1 and R, and sends the RES to the VLR. The VLR then verifies the RES based on X.

### PRIORITY CLAIM

This application claims the benefit of U.S. Provisional Application No. 60/636,906 filed Dec. 17, 2004, the entire disclosure of which is incorporated herein by reference.

### BACKGROUND

The present invention relates to user authentication. More particularly, and not by way of limitation, the present invention is directed to a method of preventing the cloning of Subscriber Identity Modules (SIMs) and enhancing protection against cloned SIMs in a cellular radio communication network or in other services making use of SIM-based authentication.

In existing second generation (2G) and third generation (3G) standards, security is based on a shared secret key, K, stored in the home operator's Authentication Center (AuC) and in the subscriber's “Identity Module” such as a Global System for Mobile Communications (GSM) Subscriber Identity Module (SIM), a Universal Mobile Telephone Service (UMTS) SIM (i.e., USIM) or an Internet Protocol Multimedia Subsystem (IMS) SIM (i.e., ISIM). The subscriber is authenticated (and charged) based on his identity, an International Mobile Station Identifier (IMSI), and a challenge-response protocol in which the subscriber proves he knows the shared secret key, K.

FIG. 1 is a message flow diagram illustrating the flow of messages in the existing authentication procedure described in detail in the Third Generation Partnership Project Technical Specification 3GPP TS 33.102, V6.2.0, which is incorporated herein by reference. The entities involved are the USIM 1, the Visitor Location Register (VLR) 2, which acts as an intermediary, and the Home Environment Authentication Center (HE/AuC) 3, which generates authentication vectors. In the description below, references to the network indicate the VLR together with the HE/AuC. The mechanism used is based on a secret key, K, shared between the USIM and the HE/AuC. Each USIM is assigned a random unique K. To achieve the (mutual) authentication, the USIM and the HE/AuC prove knowledge of the secret key to the other party.

The USIM 1 sends an authentication request 4 to the VLR 2 and includes an identifier such as an IMSI in the request. The VLR forwards the authentication request to the HE/AuC 3. When the HE/AuC receives the authentication request, the HE/AuC updates the sequence number (SQN_{HE}), selects a random value RAND, and calculates a keyed Message Authentication Code (MAC) by applying a function f1 on K, RAND, SQN_{HE}, and a message field (AMF). An expected response (XRES) is calculated with a function f2, which is defined by the operator and can be kept secret, but is of course known by the USIM and the HE/AuC. The HE/AuC also calculates keying values Ck=f3(K, RAND); Ik=f4(K, RAND); AK=f5(K, RAND); and an authentication message called AUTN=SQN XOR AK∥AMF∥MAC, all of which are defined in 3GPP TS 33.102. At 5, the HE/AuC sends the RAND, XRES, AUTN, Ck, and Ik to the VLR. At 6, the VLR sends the RAND and the message AUTN containing the SQN_{HE} (confidentiality protected), the AMF, and the MAC to the USIM.

The USIM 1 verifies the MAC, which proves that the sending entity, the network, knows the shared key, K. After this check, the USIM knows that the challenge came from his HE/AuC 3. Note however, that this does not prove that the challenge was sent to the USIM from a legitimate network, since the RAND and AUTN messages could have been intercepted by a fraudulent entity and replayed later. To protect against such replay attacks, the USIM checks the SQN_{HE} for freshness, relative to its own value, SQN_{MS}. If the USIM decides that the presented SQN_{HE} is out-of-sequence it returns an error code and a message AUTS. AUTS contains a sequence number maintained by the USIM (SEQ_{MS})(confidentiality protected) and a MAC. If the SQN_{HE} is fresh, then it has not been used earlier, and since the RAND is tied to the sequence number by the verified MAC, it implies that the RAND is also fresh. The USIM then calculates a response, RES=f2(K, RAND) and returns the RES at 7 to the VLR 2. The VLR then verifies that RES=XRES. If this check is successful, the user is considered authenticated, and the keys Ck and Ik can be used for data protection (confidentiality and integrity).

The existing standards, however, do not provide any way to detect clones using multiple copies of the same K/IMSI. The protection against “cloning” rests solely on the assumed difficulty of reverse-engineering identity modules such as the USIM, or the difficulty of learning the shared key, K. It is noted, however, that these assumed difficulties may not be all that great. First, since the shared key, K, is shared between the identity module and the HE/AuC, at some point the K must be transferred to the AuC. This transfer is a point of weakness at which a hacker or corrupted insider could learn the K. Second, if hackers/insiders compromise the HE/AuC, security fails completely, not only for a single targeted user, but more likely for all users associated with the HE/AuC. Third, some AKA algorithms (for example, the COMP128 version of GSM AKA) are weak, and access to the SIM allows easy reverse engineering of K by observing RAND/RES pairs. Fourth, the processes surrounding SIM manufacturing may open up risks of “K-leakage”.

Observed network behavior has shown that existing standards do not provide any way to detect clones using multiple copies of the same K/IMSI. Identical USIMs may be used simultaneously without problems or failures of any kind. Existing networks and USIMs are not capable of detecting clones programmed with the same K/IMSI.

Thus, what is needed in the art is a solution for preventing the cloning of SIMs, USIMs, and ISIMs and enhancing clone protection that overcomes the shortcomings of the prior art. The present invention provides such a solution.

### SUMMARY OF THE INVENTION

In one aspect, the present invention is directed to a method of preventing unauthorized duplication of an identity module (IM). The method includes generating internally within the IM, at least a first key (K1) and a second, different key (K2), wherein the generating step includes assuring that K1 cannot be derived from K2, and, in some embodiments, also that K2 cannot be derived from K1. The IM then exports K2 and an identifier (ID) to an authentication server (AS) while keeping K1 internally secret within the IM. K1 and K2 may constitute a secret/public key pair for asymmetric cryptography, in which case, the public key K2 is kept secret in the AS. Internal information in the IM utilized to generate K1 and K2 may be erased in order to assure that K1 cannot be derived from K2 and vice-versa.

Since the keys K1 and K2 are distinct, a compromise/break-in of the AS will not disclose information from which K1 can be deduced, thus preventing cloning of the IM. Similarly, the transfer of K2 from the IM to the AS does not need to be heavily protected. As will be seen, the invention is still able to maintain the signaling flows of the existing authentication protocols, but utilizes asymmetric cryptography in the processing instead of symmetric cryptography. Various detailed embodiments, using different types of asymmetric cryptography (e.g., encryption, signatures, and the like) are described below. An embodiment based on hash-chains is also described.

In another aspect, described later, it is also shown how to make K1 useless for deriving K2. This has the effect that even if the IM is compromised (in which case it will be possible to clone the IM), it will still not be possible to clone the AS (i.e., manufacture an AS that can interoperate with the IM).

In an authentication phase of the invention, a third party authenticates the IM. The authentication phase includes initiating authentication by providing from the IM to the third party, information containing at least the ID; forwarding the information from the third party to the AS; retrieving K2 by the AS based on the ID received from the third party; and generating by the AS, at least a first value (R) and a second value (X), based on at least K2. The authentication phase also includes returning R and X from the AS to the third party; forwarding R from the third party to the IM; generating by the IM, a response (RES) based on at least K1 and R; returning the RES from the IM to the third party; and verifying the RES by the third party based on X.

In another aspect, the present invention is directed to a duplication-resistant IM. The IM includes means for generating internally within the IM, at least a first key (K1) and a second key (K2) while assuring that K1 cannot be derived from K2, and K2 cannot be derived from K1; and means for exporting K2 and an identifier (ID) from the IM to an authentication server (AS) while keeping K1 internally secret within the IM. The IM may be implemented in a terminal that contains an e-commerce application performing payments based on the IM.

In yet another aspect, the present invention is directed to an authentication server for authenticating an accessing identity module (IM) while preventing unauthorized duplication of the accessing IM. The authentication server includes means for receiving an access request from an accessing IM; means for generating a challenge utilizing information stored in the authentication server but not in the accessing IM, wherein the information stored within the authentication server is not sufficient to create an IM clone; and means for generating an expected response that is expected from a valid IM. The authentication server also includes means for sending the challenge to the accessing IM, wherein the challenge varies for each access attempt.

In still yet another aspect, the present invention is directed to a system for providing a valid IM with access to a network while preventing access to the network by an unauthorized IM clone. The system includes an authentication server for receiving an access request from an accessing IM, generating a challenge utilizing information stored in the authentication server but not in the accessing IM, generating an expected response that is expected from a valid IM, and sending the challenge to the accessing IM, wherein the challenge varies for each access attempt, and the information stored in or generated by the authentication server is not sufficient to create an IM clone capable of responding as a valid IM. The system also includes means within the accessing IM for receiving the challenge, and preparing and sending a response based on information in the challenge and information stored in the accessing IM but not in the authentication server; and means for providing the accessing IM with access to the network only if the response prepared by the accessing IM equals the expected response generated by the authentication server.

The system may also include an intermediary node adapted to receive the challenge and the expected response from the authentication server, forward the challenge to the accessing IM, receive the response from the accessing IM, and determine whether the response prepared by the accessing IM equals the expected response generated by the authentication server.

In still yet another aspect, the present invention is directed to a method of providing a valid IM with access to a network while preventing access to the network by an unauthorized IM clone, wherein an accessing IM sends an access request to an authentication server. The method includes, in the authentication server, the steps of selecting a random value y; calculating a random value (RAND) utilizing RAND=g^{y}; calculating a value R=g^{xy}, where x is a Diffie-Hellman private key known to the accessing IM; calculating a shared secret key (K) utilizing K=KDF(R, . . . ), where KDF is a key derivation function; updating a sequence number (SQN_{HE}); calculating a keyed Message Authentication Code (MAC) utilizing MAC=f1(K, RAND∥SQN∥AMF . . . ); calculating an expected response (XRES) utilizing XRES=f2(K, RAND); calculating Ck utilizing Ck=f3(K, RAND); calculating Ik utilizing Ik=f4(K, RAND); calculating AK utilizing AK=f5(K, RAND); constructing a message AUTN utilizing AUTN=SQN XOR AK∥AMF∥MAC; and sending the RAND, XRES, AUTN, Ck, and Ik to a Visitor Location Register (VLR) serving the accessing IM.

The VLR forwards the RAND and AUTN containing the confidentiality-protected SQN_{HE}, a message field (AMF), and the MAC to the accessing IM. The method then includes, in the accessing IM, the steps of determining R utilizing R=RAND^{x}, where x is the Diffie-Hellman private key; calculating the shared secret key, K=KDF(R, . . . ) using the key derivation function; calculating AK using AK=f5(K, RAND); extracting and checking the SQN_{HE}, AMF, and MAC; calculating a response (RES) utilizing RES=f2(K, RAND); and sending the RES to the VLR. The VLR then determines whether the RES received from the accessing IM is equal to the XRES received from the authentication server. The accessing IM is provided with access to the network only if the RES received from the accessing IM is equal to the XRES received from the authentication server.

In still yet another aspect, the present invention is directed to a method of authenticating an accessing identity module (IM) while preventing unauthorized duplication of the accessing IM in a network utilizing a signature scheme with message recovery. A public key, U_EK, is generated internally within the accessing IM, and is enrolled at an authentication server (AS). When the accessing IM sends an access request including at least an IM identifier to the AS, the AS retrieves the accessing IM's public key, U_EK. The AS prepares a challenge, CHAL, which includes at least one of a random value (RAND), a sequence number (SEQ), and additional data (DATA). The AS sends the challenge and the accessing IM's public key, U_EK, to an intermediary node, which forwards the challenge from the intermediary node to the accessing IM. The accessing IM then prepares a digital signature U_SIGN(CHAL) of the challenge, and sends the digital signature U_SIGN(CHAL) to the intermediary node as a response, RES, to the challenge. The intermediary node verifies the response by determining whether the challenge (CHAL) equals the public key U_EK(RES).

### BRIEF DESCRIPTION OF THE SEVERAL VIEWS OF THE DRAWINGS

In the following section, the invention will be described with reference to exemplary embodiments illustrated in the figures, in which:

FIG. 1 (Prior Art) is a message flow diagram illustrating the flow of messages in an existing Third Generation Partnership Project (3GPP) authentication procedure;

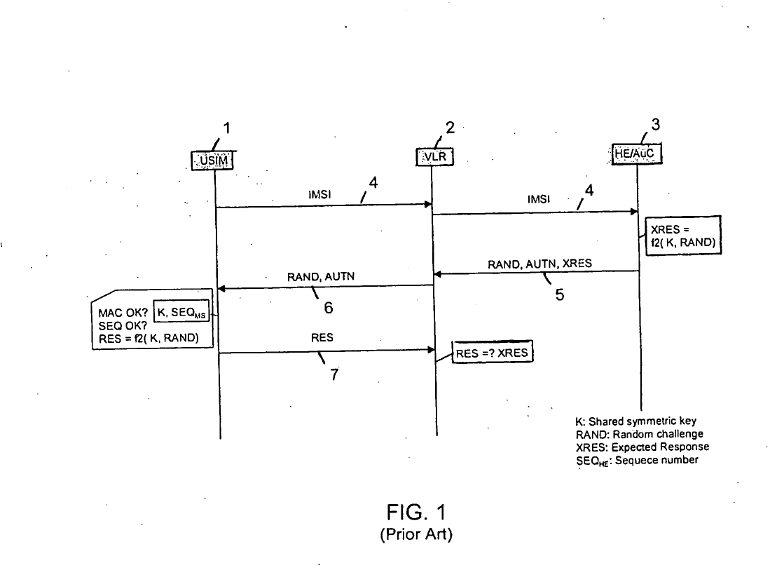

FIG. 2 is a message flow diagram illustrating the flow of messages in a first embodiment of the present invention;

FIG. 3 is a message flow diagram illustrating the flow of messages in an embodiment of the present invention utilizing a plaintext challenge system;

FIG. 4 is a message flow diagram illustrating the flow of messages in an embodiment of the present invention utilizing an encrypted challenge system;

FIG. 5 is a message flow diagram illustrating the flow of messages in an alternative embodiment of the present invention utilizing an encrypted challenge system; and

FIG. 6 is a message flow diagram illustrating the flow of messages in an alternative embodiment of the present invention utilizing a Public Key Distribution system.

### DETAILED DESCRIPTION

The present invention uses an asymmetric cryptography system to prevent the cloning of *SIMs (i.e., SIMs, USIMs, and ISIMs) and to enhance protection against cloned identity modules (IMs). In sharp contrast to prior-art arrangements (storing the same information in the *SIM and HE/AuC), the present invention stores different information in the HE/AuC from the information in the *SIM, and even if the information in the HE/AuC is leaked, it is not sufficient to clone a *SIM. In one embodiment, the *SIM generates its secret (private) public key pair internally, and securely delivers the public key to the HE/AuC. In another embodiment, a trusted third party generates the secret (private) public key pair. The trusted third party enters the secret key into the *SIM, and delivers the public key to the HE/AuC. Note that the system does not rely on a shared key as in the standard GSM/UMTS Authentication and Key Agreement (AKA) procedures.

The asymmetric schemes in the present invention may be based either on public key encryption, or on a Diffie-Hellman public key distribution system. In the first case, the secret key, U_SK equals the private key in the public key crypto system, and U_PK denotes the corresponding public key. In the second case, U_SK denotes a secret value (x) and the U_PK is the corresponding public value g^{x}.

The present invention is designed to prevent *SIM cloning by attackers having information gained in any one of the following three ways.

1. The information held in the HLR/AuC is leaked to the attacker. This implies that the attacker can, generate authentic challenges. However it does not necessarily imply that the attacker could generate a cloned USIM.

2. The information held in the VLR is leaked to the attacker. This should not enable the attacker to generate new valid challenges or give correct responses for the challenges held. The attacker should also not be able to derive the keys that result from the AKA procedure.

3. The information/parameters programmed into the USIM is leaked to the attacker. This should not enable the attacker to generate valid challenges. Note that information generated internally in the USIM is assumed not to be available to the attacker. Typically this is the private key in a public key system, and if it was available, then the attacker would obviously be able to clone the USIM. However, in one embodiment, even if the private key is made available, it would still not enable an attacker to issue valid authentication challenges, i.e., creating a false authentication server.

It is also assumed that the attacker can monitor all signaling between all involved entities up until the moment the attack is performed.

The attacks considered by the present invention are the standard attacks: (1) masquerading as a user; (2) masquerading as a system; (3) a redirection attack (i.e., to redirect authentication requests from one service to a USIM used for another service); (4) replay attacks; (5) a man-in-the-middle attack to influence keys; and (6) derivation of keys from intercepted traffic and knowledge.

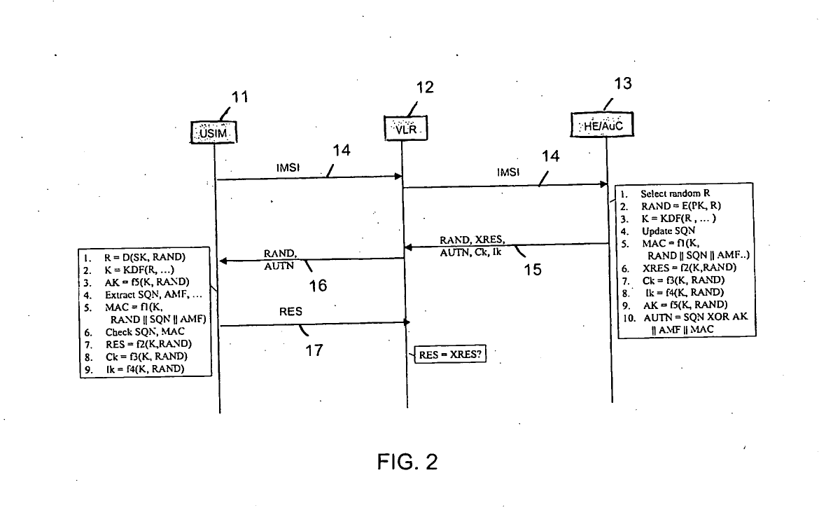

FIG. 2 is a message flow diagram illustrating the flow of messages between a *SIM such as USIM 11, a Visitor Location Register (VLR) 12, and a HE/AuC 13 in a first embodiment of the present invention. The USIM has knowledge of a secret key (SK), and the HE/AuC has knowledge of a public key (PK) corresponding to the SK. In an exemplary embodiment the RSA public key system is assumed, but as can be easily seen, any public key system may be utilized. While RSA has some special advantages (discussed later), other systems such as those based on elliptic curve could also be beneficial to use from an efficiency/bandwidth point of view. The USIM sends an authentication request 14 to the VLR and includes an identifier such as an IMSI in the request. The VLR forwards the authentication request to the HE/AuC. When the HE/AuC receives the authentication request, the HE/AuC selects a random value R, and calculates RAND=E(PK, R), where E is RSA encryption. Optionally, the HE/AuC may add redundancy/padding to R at this point, for example, according to the PKCS#1v1.5 or RSA-OAEP standards. The HE/AuC also calculates a derived shared secret key, K, using K=KDF(R, . . . ), where KDF is a key derivation function (for example, based on AES or HMAC). The HE/AuC then updates the sequence number SQN_{HE}, calculates MAC using f1(K, RAND∥SQN∥AMF . . . ), calculates XRES using f2(K, RAND), calculates Ck using f3(K, RAND), calculates Ik using f4(K, RAND), calculates AK using f5(K, RAND), and constructs the message AUTN=SQN XOR AK∥AMF∥MAC, as described in 3GPP TS 33.102. At 15, the HE/AuC sends the RAND, XRES, AUTN, Ck, and Ik to the VLR. At 16, the VLR forwards the RAND and AUTN containing the SQN_{HE} (confidentiality protected), the AMF, and the MAC to the USIM.

Upon receiving the RAND and AUTN, the USIM 11 determines R=D(SK, RAND), where D is RSA decryption. If the HE/AuC added redundancy/padding to R, the USIM checks the redundancy/padding at this point. The USIM also calculates the shared secret key, K=KDF(R, . . . ) using the key derivation function. The USIM then proceeds as in 3GPP TS 33.102 to prepare a response, RES. At 17, the USIM sends the RES to the VLR, which determines whether the RES received from the USIM is equal to the XRES received from the HE/AuC. The information in the USIM is not sufficient to generate valid challenges if an RSA-based public key scheme is utilized in which only the public key's modulus is stored in the USIM, but not the primes that the public key is formed from, and in which the public key is erased after it has been distributed to the HE/AuC.

Thus, the invention applies public key cryptography (or hash chains, described below) to secure user authentication. The public key solutions are aligned with the message exchange of the standard UMTS AKA procedure and utilize the same trust model, with a slightly modified message format and processing. The hash chain solution may require small amounts of extra signaling, except in the ISIM case, where the solution only affects home network internal signaling.

Alternatively, the present invention may use a plaintext challenge approach instead of the encrypted challenge approach described above. Both approaches assume firstly that the USIM generates a private/public key pair (internally) and enrolls the public key with the HE/AuC in a secure way. “Secure” here means authenticated, but not necessarily encrypted. The USIM operation that cannot be cloned, and which enables detection of an attack, is to perform an operation involving the private key for generation of a digital signature or to retrieve plaintext information. The plaintext challenge also assumes that the USIM and the HE/AuC share a secret, although alternatively, this assumption may be replaced with an assumption that the HE/AuC has a private/public key.

The present invention adds a general improvement to the standard UMTS AKA system as well to the new AKA solutions described below, by making the AKA output explicitly dependent on the IMSI of the USIM. This makes it impossible to program a USIM for the standard UMTS AKA procedure with the key, K, for a given user and generate correct responses.

The present invention also makes the standard UMTS AKA output dependent on the sequence number of the challenge. Including the sequence number in the response calculation prevents the output parameters from being calculated from previously used input arguments.

Plaintext Challenge System

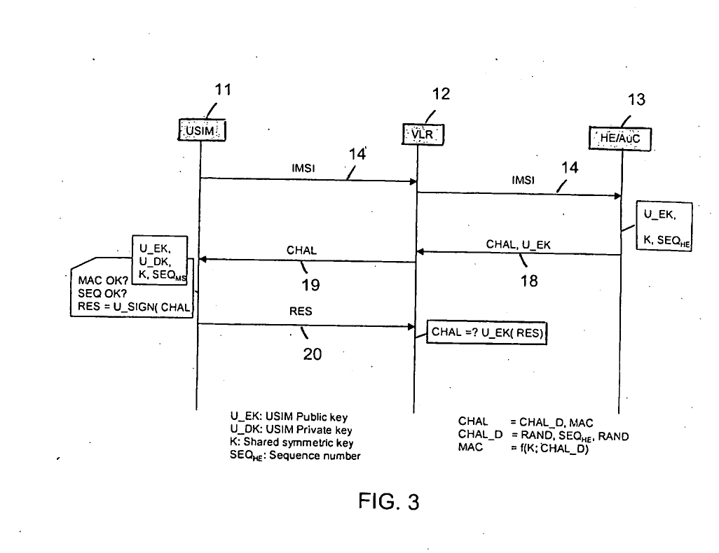

FIG. 3 is a message flow diagram illustrating the flow of messages between the USIM 11, the VLR 12, and the HE/AuC 13 in an embodiment of the present invention utilizing a plaintext challenge system. It is assumed in this embodiment that the USIM has generated and enrolled its public key (U_EK) at the HE/AuC. The USIM sends an authentication request 14 to the VLR and includes an identifier such as an IMSI in the request. The VLR forwards the authentication request to the HE/AuC. When the HE/AuC receives the authentication request, the HE/AuC retrieves the USIM's public key, U_EK, and prepares a challenge (CHAL). As in the standard UMTS AKA, the HE/AuC maintains an individual sequence counter for each USIM. The generation of sequence numbers and the SNAP employed by the USIM can be adapted to system needs, and the total system solution, due to the fact that a USIM cannot be cloned. The challenge includes at least one of RAND and SEQ, and possibly additional data (DATA). Preferably, both RAND and SEQ are part of the challenge, which preferably includes a service identifier in the DATA part. The service indicator makes it impossible to redirect challenges from one service and use the results for another service.

At 18, the HE/AuC sends the challenge (CHAL) together with the USIM's public key (U_EK) to the VLR 12, which forwards the CHAL to the USIM at 19. The USIM prepares a digital signature U_SIGN(CHAL) of the challenge and sends it as a response (RES) 20 to the VLR, which then checks the signature by determining whether the challenge (CHAL) equals the public key U_EK(RES).

In the embodiment of FIG. 3, a signature scheme with message recovery is assumed. If signatures with an appendix are used, the check CHAL=? U_EK(RES) is replaced by hash(CHAL)=? U_EK(RES). To protect against denial-of-service attacks and verify that the challenge comes from an authenticated source, the challenge together with the user's public key may be integrity protected with a shared-key MAC. The HE/AuC may alternatively digitally sign the challenge using either a common public/private key pair for all users or USIM unique public/private key pairs. In the latter case, the public key may be distributed to the USIM at the same time that the USIM enrolls its public key with the HE/AuC. By integrity protecting the challenge in this manner, it is not possible for an attacker to produce valid challenges for all cases, except when he has the same knowledge as the HE/AuC. Thus, the attacker cannot send challenges to block valid sequence numbers.

The shared key may also be used as in the standard UMTS AKA system to derive shared keys such as Ck and Ik. In this derivative embodiment, the keys preferably depend on the complete challenge, not just the RAND part. This guarantees that keys will also depend on the sequence number and the DATA part. If the terminal or the USIM can verify that a service descriptor in the data part, for example, is correct, then redirection attacks are blocked. Note that the derived shared keys must be sent from the HE/AuC to the VLR.

The method to hide the sequence number offered by the standard UMTS AKA system also applies for this solution.

It is also noted that if the shared key in the USIM is leaked, an attacker can generate valid challenges, because the public key of the USIM has to be considered publicly known since it is sent to the VLR in plaintext. If the challenge is signed with a HE/AuC private key, this is not the case. An attacker may in this case also be able to “hijack” a connection after the real USIM has authenticated because the attacker may be able to derive the same session keys. To protect against this, the keys should be derivable only when one has possession of the secret (non-shared) key in the USIM. This may be accomplished by having the HE/AuC send a “key seed” to the USIM, encrypted by the USIM's public key, as was performed in the earlier described encrypted challenge solution.

Alternative Encrypted Challenge System

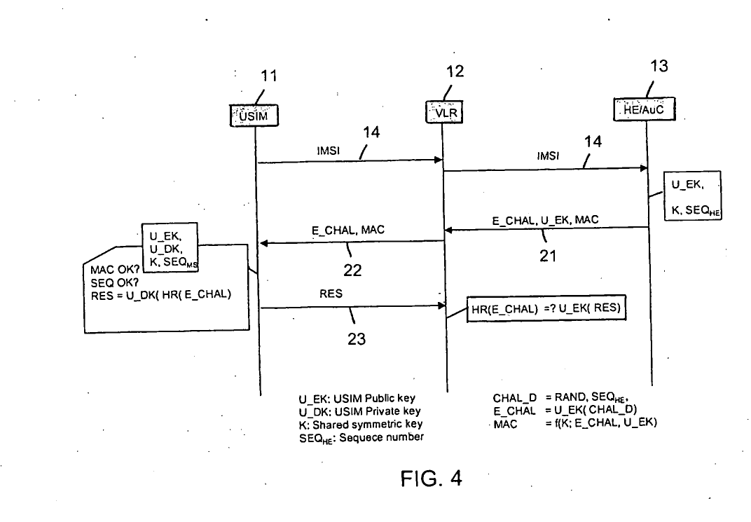

FIG. 4 is a message flow diagram illustrating the flow of messages between the USIM 11, the VLR 12, and the HE/AuC 13 in an alternative embodiment of the present invention utilizing an encrypted challenge system. There are two major differences between this embodiment and the encrypted challenge embodiment described above. First, in this embodiment, integrity protection is provided by having the USIM and HE/AuC share a secret key. Second, in this embodiment, the USIM public key is made available to the VLR. It is assumed in this embodiment that the USIM has generated and enrolled its public key (U_EK) at the. HE/AuC. Just as described above, the HE/AuC may alternatively use a public/private key pair to digitally sign the challenges.

The USIM sends an authentication request 14 to the VLR and includes an identifier such as an IMSI in the request. The VLR forwards the authentication request to the HE/AuC. When the HE/AuC receives the authentication request, the HE/AuC retrieves the USIM's public key, U_EK, and prepares and encrypts a challenge (E_CHAL). At 21, the HE/AuC sends the E_CHAL together with the USIM's public key (U_EK) and MAC to the VLR 12, which forwards the E_CHAL and the MAC to the USIM at 22. As noted, the transfer of the public key, U_EK, to the VLR is a second major difference to the earlier described encrypted challenge embodiment. The USIM modifies the encrypted challenge E_CHAL by application of a publicly known function HR. The USIM digitally signs the obtained result, and at 23, the signature is sent as a response (RES) to the VLR. The VLR knows the HR function and the USIM's public key, and therefore it can verify the signature received.

Shared keys may be derived from the challenge by applying a HASH (PRG) function on the plaintext challenge, CHAL_D. Also here, the derived shared keys must be sent from the HE/AuC to the VLR.

It is also noted that if the shared key in the USIM is leaked, an attacker can also in this case generate valid challenges. If the challenge is signed with a HE/AuC private key, this is not the case and AKA keys could be derived from the plaintext challenge.

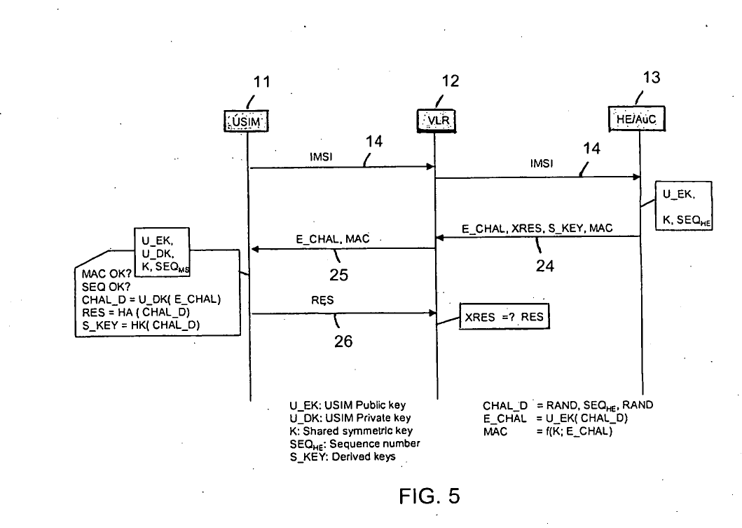

FIG. 5 is a message flow diagram illustrating the flow of messages between the USIM 11, the VLR 12, and the HE/AuC 13 in a third alternative embodiment of the present invention utilizing an encrypted challenge system. In this embodiment, the public key of the USIM is not sent to the VLR as in the preceding embodiment. The USIM sends an authentication request 14 to the VLR and includes an identifier such as an IMSI in the request. The VLR forwards the authentication request to the HE/AuC. When the HE/AuC receives the authentication request, the HE/AuC retrieves the USIM's public key, U_EK, and prepares and encrypts a challenge (E_CHAL). The HE/AuC also derives the S_KEY to be shared with the VLR 12. At 24, the HE/AuC sends the E_CHAL together with the expected response (XRES), the S_KEY, and the MAC to the VLR 12, which forwards the E_CHAL and the MAC to the USIM at 25. The USIM prepares a response (RES) as a HASH or pseudo-random generator (PRG) of the plaintext challenge CHAL_D, HA(CHAL_D). At 26, the RES is sent to the VLR, which determines whether the RES received from the USIM is equal to the XRES received from the HE/AuC.

To maintain the feature that the information held by the VLR is not sufficient to generate valid responses to a challenge, a masking technique is applied. The same type of masking technique may be used to make the derived shared keys depend on the response generated by the USIM. This method is also applicable to both solutions described above.

It is also noted that in this embodiment there is no shared key. The information in the USIM is not sufficient to generate valid challenges if an RSA-based public key scheme is utilized in which only the public key's modulus is stored in the USIM, but not the primes that the public key is formed from, and in which the public key is erased after it has been distributed to the HE/AuC.

Solution Based on Hash Chains

The benefits of a hash-based solution is efficiency, although the signaling and maintenance is somewhat more complicated. A principle of digital signatures is that the signer reveals a value that only the signer can produce, but anybody is able to verify the correctness. The same result can, in principle, be achieved with one-way hash functions. Starting with a function h, which is easy to compute but hard to invert, a “signer” A chooses a random x and publishes y(=h(x)) as a “public key”. Later, signer A reveals x, and anybody can apply h and verify that the value is correct. To be able to “sign” more than once, one can use a chain
X_{—}0=random,
X_{—}j=h(X_(j−1)), j=1, 2, . . .
A problem is that such a chain will anyway always be of finite length, and one may run out of X-values. However, in the USIM case, there is usually a maximum number of allowed authentications defined (about 20000-50000), so the chain can always be made long enough. Alternatively, there are methods to “bootstrap” new chains from old. This is done by letting the second to last value of a first hash chain be used as a message integrity key, this key integrity protecting the last value of a second hash chain.

Thus, the USIM generates a hash chain {X_j} as signer A above, and the last “anchor” value, X_N, is enrolled in the AuC. To reduce storage requirements, the USIM may store, for example, only every r:th value, and derive intermediate values as necessary. In principle, at each authentication, the USIM reveals the “next” X_j (which is the previous X-value in the chain). This, however, has some synchronization problems, since the home network needs to know how many authentications have taken place in order to supply the correct X-value. This may not always be easy, since the home may have difficulty in “tracking” the user when roaming.

A solution is for the USIM, via the VLR, to “report home”, at least at given intervals. The AuC stores (j, X_j), which is the most recently reported hash chain value. (Alternatively, since j will be in correspondence to N and SQN by j=N−SQN, then N and SQN can be used to deduce j, see below.) The home network always knows what SQN was used in connection with a particular challenge-response (AKA vector). Therefore, whenever the VLR reports back a particular X_j, the AuC can update its value accordingly. Next time, when a VLR requests AKA parameters, the AuC looks up the most recent (j, X_j) value. The AuC produces an AKA vector, and includes X_j and the integer T=SQN−j. This value T is how many times the VLR needs to apply h to the X_k value revealed by the USIM in order to get X_j.

It should be noted that the VLR can order more than one AKA vector at once and store them for later use. Suppose for instance that the VLR orders M>1 vectors. A “malicious” VLR may then take the last of these vectors (rather than the first as normally expected) and send to the USIM. When the USIM reveals the corresponding X_n, the VLR will be able to produce a cloned USIM that is good for M successive authentications if the VLR also has access to K. In general, such caveats exist if someone is able to compromise both the VLR and the USIM (to get K). In the IP Multimedia Subsystem (IMS), authentication is done in the home network. Therefore, the solution is more suited there (to ISIMs), since the “report home” function is essentially in place already.

Solution Based on Diffie Hellman

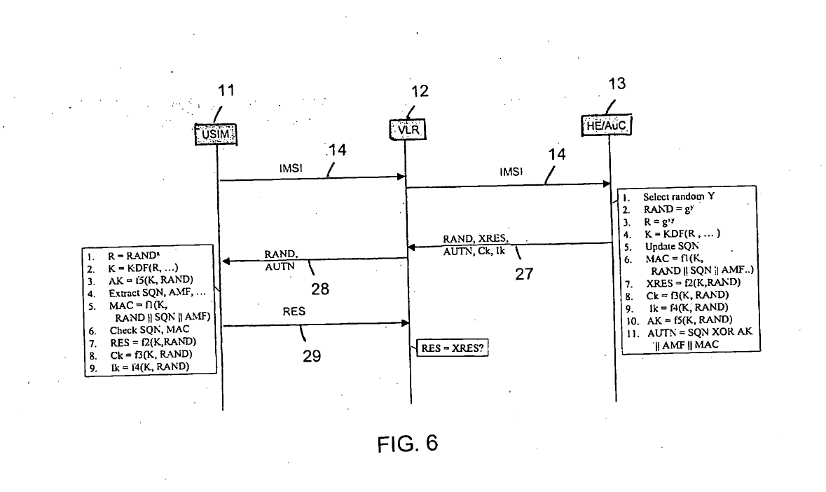

FIG. 6 is a message flow diagram illustrating the flow of messages between the USIM 11, the VLR 12, and the HE/AuC 13 in an embodiment of the present invention utilizing a Public Key Distribution system rather than Public Key Encryption. The solution may be illustrated using the standard Diffie-Hellman method. The USIM has knowledge of a Diffie-Hellman secret key (x), and the HE/AuC has knowledge of a Diffie-Hellman public key (g^{x}). Note that g^{x} can be easily computed from x, but the opposite is presumed computationally infeasible. The USIM sends an authentication request 14 to the VLR and includes an identifier such as an IMSI in the request. The VLR forwards the authentication request to the HE/AuC. When the HE/AuC receives the authentication request, the HE/AuC selects a random value y, and calculates RAND=g^{y}. The HE/AuC then calculates a value R=g^{xy}, based on the public key g^{x}, where the value x is the Diffie-Hellman private key. The HE/AuC also calculates the shared secret key, K, using K=KDF(R, . . . ), where KDF is a key derivation function. The HE/AuC then updates the sequence number SQN_{HE}, calculates MAC using f1(K, RAND∥SQN∥AMF . . . ), calculates XRES using f2(K, RAND), calculates Ck using f3(K, RAND), calculates Ik using f4(K, RAND), calculates AK using f5(K, RAND), and constructs the message AUTN=SQN XOR AK∥AMF∥MAC, as described in 3GPP TS 33.102. At 27, the HE/AuC sends the RAND, XRES, AUTN, Ck, and Ik to the VLR. At 28, the VLR forwards the RAND and AUTN containing the SQN_{HE} (confidentiality protected), the AMF, and the MAC to the USIM 11.

Upon receiving the RAND and AUTN, the USIM 11 determines R=RAND^{x}, where x is the Diffie-Hellman private key. This step may be expressed as:
D(SK, RAND)=D(x,RAND)=RAND^{x}.

The USIM also calculates the shared secret key, K=KDF(R, . . . ) using the key derivation function. The USIM then proceeds as in 3GPP TS 33.102 to prepare a response, RES. At 29, the USIM sends the RES to the VLR, which determines whether the RES received from the USIM is equal to the XRES received from the HE/AuC.

In one embodiment, relating to the public key or Diffie-Hellman cases, secret information is stored in the IM and protected by a password so that it can only be used by initializing the IM, for example, by entering appropriate initializing information. The secret information may include a secret key, a public key, or both. Appropriate initializing information may be used to initiate generation of secret information and to output, for example; a public key that is further exported to an AuC. This initializing information is not known to the ordinary user, and consequently, the public key is not known to the ordinary user. Other appropriate initializing information may be used at the time a user performs authentication requiring use of a private key. By applying the appropriate initializing information, use of a previously created private key is enabled, or the information initiates recreation of the keys based on a pre-stored seed. In the latter case, it should be noted that, prior to applying the initializing information, no keys are available at the mobile equipment. Electronic circuits implementing these features are disclosed in the international patent application PCT/SE03/01660, incorporated herein by reference.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of preventing unauthorized duplication of an identity module (IM), said method comprising:
generating internally within the IM, at least a first key (K1) and a second, different key (K2), wherein the generating step includes assuring that K1 cannot be derived from K2, and K2 cannot be derived from K1; and
exporting K2 and an identifier (ID) from the IM to an authentication server (AS) while keeping K1 internally secret within the IM.

2. The method of claim 1, wherein K1 and K2 constitute a secret/public key pair for asymmetric cryptography, and wherein the method further comprises keeping the public key K2 secret in the AS.

3. The method of claim 2, wherein the step of assuring K2 cannot be derived from K1 includes erasing internal information in the IM utilized to generate K1 and K2.

4. The method of claim 1, wherein the step of exporting includes initializing the IM to receive K2 at an output for export to the AS while keeping K1 internally secret within the IM.

5. The method of claim 4, wherein the step of initializing includes applying an initializing code to an input port of the IM.

6. The method of claim 1, further comprising an authentication phase, wherein a third party authenticates the IM, said authentication phase comprising:
providing from the IM to the third party, information initiating authentication, said information containing at least the ID;
forwarding the information from the third party to the AS;
retrieving K2 by the AS based on the ID received from the third party;
generating by the AS, at least a first value (R) and a second value (X), based on at least K2;
returning R and X from the AS to the third party;
forwarding R from the third party to the IM;
generating by the IM, a response (RES) based on at least K1 and R;
returning the RES from the IM to the third party; and
verifying the RES by the third party based on X.

7. The method of claim 6, wherein:
the step of generating R includes encrypting a value V using K2, wherein V contains information for deriving X;
the step of generating the RES includes decrypting R and verifying information derived from the decryption of R; and
the step of verifying the RES by the third party based on X is a comparison that RES is equal to X.

8. The method of claim 1, wherein K1 is a first secret for a public key exchange system, and K2 is a corresponding public parameter.

9. An identity module (IM), resistant to duplication, comprising:
means for generating internally within the IM, at least a first key (K1) and a second key (K2) while assuring that K1 cannot be derived from K2, and K2 cannot be derived from K1; and
means for exporting K2 and an identifier (ID) from the IM to an authentication server (AS) while keeping K1 internally secret within the IM.

10. The identity module of claim 9, wherein the IM is implemented in a terminal that contains an e-commerce application, said e-commerce application performing payments based on the IM.

11. An authentication server for authenticating an accessing identity module (IM) while preventing unauthorized duplication of the accessing IM, said authentication server comprising:
means for receiving an access request from the accessing IM;
means for generating a challenge utilizing information stored in the authentication server but not in the accessing IM, wherein the information stored in the authentication server is not sufficient to generate an IM clone capable of responding as a valid IM;
means for generating an expected response that is expected from a valid IM; and
means for sending the challenge to the accessing IM, wherein the challenge varies for each access attempt.

12. A system for providing a valid identity module (IM) with access to a network while preventing access to the network by an unauthorized IM clone, said system comprising:
an authentication server for receiving an access request from an accessing IM, generating a challenge utilizing information stored in the authentication server but not in the accessing IM, generating an expected response that is expected from a valid IM, and sending the challenge to the accessing IM, wherein the challenge varies for each access attempt, and the information stored in or generated by the authentication server is not sufficient to create an IM clone capable of responding as a valid IM;
means within the accessing IM for receiving the challenge, and preparing and sending a response based on information in the challenge and information stored in the accessing IM but not in the authentication server; and
means for providing the accessing IM with access to the network only if the response prepared by the accessing IM equals the expected response generated by the authentication server.

13. The system of claim 12, wherein the accessing IM also includes means for determining whether a sequence number received from the authentication server is fresh.

14. The system of claim 12, further comprising an intermediary node adapted to receive the challenge and expected response from the authentication server, forward the challenge to the accessing IM, receive the response from the accessing IM, and determine whether the response prepared by the accessing IM equals the expected response generated by the authentication server.

15. A method of providing a valid identity module (IM) with access to a network while preventing access to the network by an unauthorized IM clone, wherein an accessing IM sends an access request to an authentication server, said method comprising:
in the authentication server:
selecting a random value y;
calculating a random value (RAND) utilizing RAND=g^{y};
calculating a value R=g^{xy}, where x is a Diffie-Hellman private key known to the accessing IM, and g^{x} is known to the authentication server;
calculating a shared secret key (K) utilizing K=KDF(R, . . . ), where KDF is a key derivation function;
sending the RAND and an expected response (XRES) to an intermediary node; and
forwarding the RAND from the intermediary node to the accessing IM; and
in the accessing IM:
determining R utilizing R=RAND^{x}, where x is the Diffie-Hellman private key;
calculating the shared secret key, K=KDF(R, . . . ) using the key derivation function;
calculating a response (RES) utilizing RES=f2(K, RAND); and
sending the RES to the intermediary node;
determining by the intermediary node, whether the RES received from the accessing IM is equal to the XRES received from the authentication server; and
providing the accessing IM with access to the network only if the RES received from the accessing IM is equal to the XRES received from the authentication server.

16. The method according to claim 15, further comprising:
in the authentication server:
updating a sequence number (SQN_{HE});
calculating a keyed Message Authentication Code (MAC) utilizing MAC=f1(K, RAND∥SQN∥AMF . . . );
calculating the XRES utilizing XRES=f2(K, RAND);
calculating a key Ck utilizing Ck=f3(K, RAND);
calculating a key Ik utilizing Ik=f4(K, RAND);
calculating AK utilizing AK=f5(K, RAND);
constructing an authentication message AUTN utilizing AUTN=SQN XOR AK∥AMF∥MAC; and
sending the AUTN to the intermediary node together with the RAND and the XRES;
in the intermediary node:
forwarding the AUTN to the accessing IM together with the RAND; and
in the accessing IM;
calculating AK using AK=f5(K, RAND); and
extracting and checking the SQN_{HE}, AMF, and MAC from the AUTN.

17. A method of authenticating an accessing identity module (IM) while preventing unauthorized duplication of the accessing IM, said method comprising:
generating internally within the accessing IM, at least a first key (K1) and a second, different key (K2); and
exporting K2 and an identifier (ID) from the accessing IM to an authentication server (AS) while keeping K1 internally secret within the accessing IM;
sending from the accessing IM to a third party, information containing at least the ID;
forwarding the information from the third party to the AS;
retrieving K2 by the AS based on the ID received from the third party;
selecting by the AS a random number R;
generating by the AS, at least a value (RAND) based on at least the number R;
generating by the AS a key K based on at least the number R;
generating by the AS a value (X) based on at least the value (RAND) and the key K;
returning the value RAND and X from the AS to the third party;
forwarding the value RAND from the third party to the accessing IM;
receiving by the third party, a response, RES from the accessing IM; and
verifying the RES by the third party based on X.

18. The method according to claim 17, further comprising, prior to the step of receiving the RES from the accessing IM, the steps of:
calculating by the accessing IM, the random number R based at least on the key K1 and the value (RAND);
calculating by the accessing IM, the key K based on at least the value R; and
calculating by the accessing IM the response RES based on at least the key K and the value RAND.

19. The method according to claim 18, wherein:
the accessing IM calculates a value R1 utilizing R1=RAND^{K1};
the accessing IM calculates the key K utilizing K=KDF(R1, . . . ); and
the accessing IM calculates the response RES utilizing RES=f2(K, RAND).

20. The method according to claim 17, further comprising determining by the AS, a random number R1=(K2)^{R} utilizing the random number R;
wherein the AS generates the value RAND according to RAND=g^{R};
wherein the AS generates the key K utilizing K=KDF(R1, . . . ), where KDF is a key derivation function; and
wherein the AS generates the value X utilizing X=f2(K, RAND), utilizing a function f2.

21. A method of authenticating an accessing identity module (IM) while preventing unauthorized duplication of the accessing IM in a network utilizing a signature scheme with message recovery, said method comprising:
generating a public key, U_EK, internally within the accessing IM;
enrolling the public key, U_EK, at an authentication server (AS);
sending an access request from the accessing IM to the AS, said access request including at least an identifier for the accessing IM;
retrieving by the AS, the accessing IM's public key, U_EK;
preparing a challenge, CHAL, by the AS, said challenge including at least one of a random value (RAND), a sequence number (SEQ), and additional data (DATA);
sending the challenge and the accessing IM's public key, U_EK, from the AS to an intermediary node;
forwarding the challenge from the intermediary node to the accessing IM;
preparing by the accessing IM, a digital signature U_SIGN(CHAL) of the challenge;
sending the digital signature U_SIGN(CHAL) from the accessing IM to the intermediary node as a response, RES, to the challenge; and
verifying the response by the intermediary node by determining whether the challenge (CHAL) equals the public key U_EK(RES).

22. The method according to claim 21, wherein the challenge (CHAL) includes both RAND and SEQ.

23. The method according to claim 22, wherein the challenge (CHAL) also includes the DATA part, wherein the DATA part includes a service identifier.

24. A method of authenticating an accessing identity module (IM) while preventing unauthorized duplication of the accessing IM in a network utilizing signatures with an appendix, said method comprising:
generating a public key, U_EK, internally within the accessing IM;
enrolling the public key, U_EK, at an authentication server (AS);
sending an access request from the accessing IM to the AS, said access request including at least an identifier for the accessing IM;
retrieving by the AS, the accessing IM's public key, U_EK;
preparing a challenge, CHAL, by the AS, said challenge including at least one of a random value (RAND), a sequence number (SEQ), and additional data (DATA);
sending the challenge and the accessing IM's public key, U_EK, from the AS to an intermediary node;
forwarding the challenge from the intermediary node to the accessing IM;
preparing by the accessing IM, a digital signature U_SIGN(hash(CHAL)) of the challenge;
sending the digital signature U_SIGN(hash(CHAL)) from the accessing IM to the intermediary node as a response, RES, to the challenge; and
verifying the response by the intermediary node by determining whether the hash of the challenge, hash(CHAL), equals the public key U_EK(RES).
